(19) United States
(12) Patent Application Publication
(10) Pub. No.: US 2016/0333131 A1
(43) Pub. Date: Nov. 17, 2016

(54) ACTIVE ENERGY RAY-CURABLE COMPOSITION FOR FLOORING MATERIALS AND INSTALLATION METHOD THEREFOR

(71) Applicant: DIC CORPORATION, Tokyo (JP)

(72) Inventors: Kazunari Kawai, Tokyo (JP); Shingo Kusano, Tokyo (JP)

(73) Assignee: DIC CORPORATION, Tokyo (JP)

(21) Appl. No.: 15/112,217

(22) PCT Filed: Jan. 15, 2015
(86) PCT No.: PCT/JP2015/050940

§ 371 Date: Jul. 18, 2016

(30) Foreign Application Priority Data
Jan. 22, 2014 (JP) 2014-009456
Feb. 3, 2014 (JP) 2014-018451

(51) Int. Cl. C08F 290/06; C08K 3/08

(52) U.S. Cl. CPC C08F 290/067; C08K 3/08; C08K 2003/0806; C08F 2800/20; E04F 15/10

(57) ABSTRACT

Provided are an active energy ray-curable composition fox flooring materials, which is unlikely to cause a curing defect between a cured portion and an uncured portion even when a movable curing device having a light source is used is unlikely to cause yellowing attributable to exposure to natural light for a long period of time, and exhibits a high re-coatability, while exhibiting conventional physical performance, and a construction method therefor. Further, also provided are an active energy ray-curable composition for antibacterial flooring materials, which has antibacterial properties, and a construction method therefor. The active energy ray-curable composition for flooring materials is formed by appropriately applying a specific carboxyl group-containing active energy ray-polymerizable compound, a specific urethane oligomer, a specific hyperbranched oligomer, specific polyfunctional acrylate, and a specific photopolymerization initiator in combination.

### TECHNICAL FIELD

The present invention relates to an active energy ray-curable composition for flooring materials and a construction method therefor.

### BACKGROUND ART

Hitherto, flooring materials made of synthetic resins such as polyvinyl chloride have been widely used as floor finishing materials for buildings and vehicles. Flooring materials made of synthetic resins are likely to be attached to dirt (heel mark) due to friction between the Materials and shoe soles at the time when a person is wearing shoes and walking, and thus, the flooring materials generally are poor in contamination resistance. Therefore, an antifouling treatment such as a waxing treatment is usually carried out after construction of the flooring materials. However, in order to maintain antifouling properties, it is necessary to perform maintenance of periodically removing old wax and carrying out a waxing treatment, again. This maintenance work is high in cost and time-consuming, and further has many disadvantages in terms of environment, for example, the work causes a large amount of liquid waste.

As flooring materials which do not need to be subjected to the antifouling treatment such as waxing, flooring materials which are coated with a composition to be cured by active energy rays such as UV rays or electron beams have been proposed (for example, see PTLs 1 and 2). An active energy ray-curable composition is a composition which is instantaneously cured by a cross-linking reaction when irradiated with the active energy rays. Further, when the active energy ray-curable composition is applied to flooring materials, it is possible to provide an excellent contamination resistance for the flooring materials. However, although the flooring materials coated with the composition cured by the active energy rays have an excellent contamination resistance, yellowing caused by exposure to natural light for a long period of time occurs, and thus it cannot be said that the flooring materials have sufficient stability after construction.

From the viewpoint of improving the abrasion resistance and the scratch resistance, flooring materials in which the number of functional groups and molecular weight of oligomers are specified and to which organic particles or inorganic particles are incorporated have been proposed (for example, see PTL 3). However, in a case where a movable active energy ray irradiation device is used, a curing defect is likely to occur between a cured portion and an uncured portion.

In addition, antibacterial properties are occasionally expressed since a urethane oligomer passes through a plasticizer used for polyvinyl chloride, but, even when organic particles or inorganic particles are incorporated, the contamination resistance (heel mark resistance) and scratch resistance are not sufficient.

### CITATION LIST

Patent Literature

[PTL 1] JP-A-6-136668

[PTL 2] JP-A-6-256444

[PTL 3] JP-A-2012-136673

### SUMMARY OF INVENTION

### Technical Problem

An object of the present invention is to provide an active energy ray-curable composition for flooring materials, which is unlikely to cause a curing defect between a cured portion and an uncured portion even when a movable curing device having a light source is used, is unlikely to cause yellowing attributable to exposure to natural light for a long period of time, and has a high re-coatability, while exhibiting conventional physical performance and, a construction method therefor. Further, another object thereof is to provide an active energy ray-curable composition for antibacterial flooring materials, which has antibacterial properties, and a construction method therefor.

### Solution to Problem

The above-described problem is solved, by the present inventors, by appropriately applying a specific carboxyl group-containing active energy ray-polymerizable compound, a specific urethane oligomer, a specific hyperbranched oligomer, specific polyfunctional acrylate, and a specific photopolymerization initiator, in combination.

The present invention is to provide an active energy ray-curable composition for flooring materials, which contains an active energy ray-polymerizable compound and a photopolyiaerization initiator, in which the active energy ray-polymerizable compound contains the following materials (a), (b), (c), and (d):

(a) a carboxyl group-containing active energy ray-polymerizable compound represented by Formula (1),

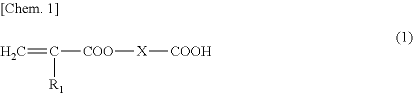

wherein R1 represents a hydrogep atom or a methyl group, and X represents an organic group;

(b) a urethane oligomer;

(c) a hyperbranched oligomer; and

(d) polyfunctional acrylate.

Further, the present invention is to provide the active energy ray-curable composition for flooring materials, in which the photopolymerization initiator is methyl benzoyl formate.

The present invention is to provide the active energy ray-curable composition for flooring materials, further including (e) an antibacterial agent.

Furthermore, the present invention is to provide the active energy ray-curable composition for flooring materials, in which the (e) antibacterial agent is a silver-based antibacterial agent.

Furthermore, the present invention is to provide the active energy ray-curable composition for flooring materials, still further including (f) an acrylic leveling agent added for the purpose of improving surface smoothness.

Furthermore, the present invention is to provide a construction method including: curing the active energy ray-curable composition for flooring materials using a movable active energy ray irradiation device.

Furthermore, the present invention is to provide flooring materials which are obtained by the construction method.

Furthermore, the present invention is to provide a floor for which the flooring materials obtained by the construction method are used.

### Advantageous Effects of Invention

According to the present invention, it is possible to provide an active energy ray-curable composition for flooring materials, which exhibits an excellent contamination resistance, is less likely to cause a curing defect between a cured portion and an un cured portion in the case of irradiation with active energy rays using a movable curing device, is less likely to cause yellowing by exposure to natural light for a long period of tim in comparison with a conventional one and thus, has a high stability after construction, and has a high re-coatability, and a construction method therefor. Further, in addition to this, it is possible to provide an active energy ray-curable composition for antibacterial flooring materials, which has antibacterial properties, and a construction method therefor.

### BRIEF DESCRIPTION OF DRAWINGS

FIG. 1 is a diagram of a grind gauge used for investigating the absence or presence of a defect which may be generated in a coating film, after application of an active energy ray-curable composition for flooring materials of the present invention, irradiation with active energy rays and curing of the composition, and the depth of the generated defect.

FIG. 2 is a diagram showing an example of an oblique portion D and a zip line E using the grind gauge shown in FIG. 1.

### DESCRIPTION OF EMBODIMENT

[(a) Active Energy Ray-Polymerizable Compound Including Carboxyl Group]

As a carboxyl group-containing active energy ray-polymerizable compound to be used in the present invention, a monomer and an oligomer containing a carboxyl group and a (meth)acrylic group are exemplified.

As the monomer containing a carboxyl group and a (meth)acrylic group, (a) a carboxyl group-containing active energy ray-polymerisable compound represented by Formula (1) is exemplified.

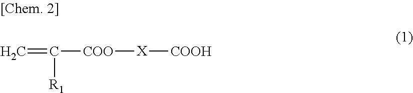

[In the formula, R1 represents a hydrogen atom or a methyl group, and X represents a divalent organic group.] It is preferable that the compound is represented by this formula. Examples of the divalent organic group include an alkylene group, an arylene group, an alkarylene group, and a —Al—(OOC—A2)n— group (here, A1 and A2 represent an alkylene group, an arylene group, or an alkarylene group, and n represents an integer of 1 or greater).

As the (a) active energy ray-polymerizable compound including a carboxyl group, an oligomer containing a carboxyl group and a (meth)acrylic group is exemplified. The oligomer is an oligomer derived from a monomer containing a carboxyl group and a (meth)acrylic group and is typically a dimer to an icosamer. Specifically, compounds represented by the following Formulae (2) to (6) are exemplified.

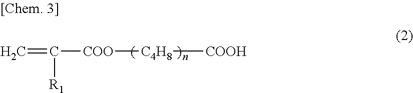

[In the formula, R1 represents a hydrogen atom or a methyl group, and n represents an integer of 1 to 10.]

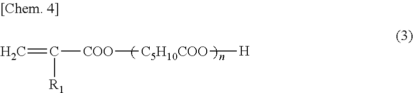

[In the formula, R1 represents a hydrogen atom or a methyl group, and n represents an integer of 1 to 10.]

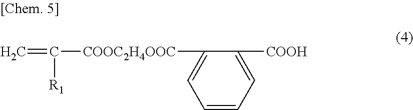

[In the formula, R1 represents a hydrogen atom or a methyl group.]

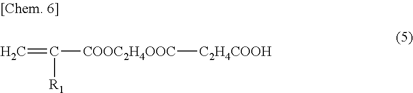

[In the formula, R1 represents a hydrogen atom or a methyl group.]

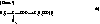

[In the formula, R1 represents a hydrogen atom or a methyl group, and n represents an integer of 1 to 10.]

Examples of the commercially available products thereof include Aronix M-5300 and M-5400 (both manufactured by Toagosei Company, Ltd.), NK ESTER SA and ASA (both manufactured by Shin-Nakamura Chemical Co., Ltd.), VISCOAT #2000, #2100, #2150, and #2180 (all manufactured by OSAKA ORGANIC CHEMICAL INDUSTRY LTD.), and Photomer4703 (manufactured by IGM, Inc.).

The content of the (a) carboxyl group-containing active energy ray-polymerizable compound components used in the present invention is in a range of 5% to 40% by weight based on the total content of the composition. The content thereof is particularly preferably in a range of 7% to 30% by weight. When the ratio of the carboxyl group-containing active energy ray-polymerizable compound components is less than 5% by weight, the contamination resistance and properties of adhesion to a base material are degraded. Mien the ratio thereof exceeds 40% by weight, curability, water resistance, and alkali resistance are degraded.

Even when the active energy ray-polymer izable compound is a compound other than the above-described (a) carboxyl group-containing active energy ray-polymerizable compound used in the present invention, there is no restriction. Specific examples thereof include a combinable active energy ray-polymerizable compound described below.

[(b) Urethane Oligomer]

(b) A urethane oligomer contained in the active energy ray-curable composition for flooring materials according to an embodiment is a compound which is cross-linked or polymerized by irradiation with light. In addition, the urethane oligomer is a compound using a polymer of monomers as a main chain, and the number of monomers constituting the main chain is not limited. The molecular weight of the (b) urethane oligomer is preferably in a range of 500 to 20,000.

The number of functional groups of the (b) urethane oligomer is preferably in a range of 2 to 20, more preferably in a range of 4 to 20, and still more preferably in a range of 6 to 20. The functional group included in the oligomer is a photopolymerizable functional group. The photopolymerizable functional group is a double bond or the like of carbon-carbon, such as an acryloyl group. When the number of functional groups is large, curing sensitivity of the curable oligomer becomes high and the hardness of a cured coating film is also enhanced. Meanwhile, when the number of functional groups is excessively large, shrinkage of a cured coating film is likely to occur and the surface of the coating film is likely to be distorted.

The glass transit ion temperature (Tg) of the (b) urethane oligomer is preferably 40° C. or higher, more preferably 50° C. or higher, and still more preferably 70° C. or higher. The glass transition temperature (Tg) can be measured by differential scanning calorimetry (DSC) or thermal mechanical analysis (TMA).

The viscosity of the (b) urethane oligomer is not particularly limited, but the viscosity thereof at 25° C. is preferably in a range of 100 to 10,000 raPa·s, more preferably 7,000 mPa·s or less, and still more preferably 5,000 mPa·s or less in consideration of the influence on the handling properties and the viscosity of the active energy ray-curable composition.

The main chain of the (b) urethane oligomer may be polyepozyaliphatic polyyurethane, aromatic polyurethane, aliphatic polyester, aromatic polyester, polyamine, or polyacrylate. It is preferable that the above-described photopolymerizable functional group is added to the main chain of the oligomer.

The following (photopolymerizable) functional, group-containing compounds can be reacted with the main chain of the oligomer by the functional group of the (b) urethane oligomer and then introduced thereto. Examples of the (photopolymerizable) functional group-containing compound include unsaturated carboxylic acid such as (meth) acrylic acid, itaconic acid, crotonic acid, isocrotonic acid, or maleic acid and salts or esters thereof, urethane, an amide and an anhydride thereof, acrylonitrile, styrene, various unsaturated polyesters, unsaturated polyether, unsaturated polyamide, and unsaturated urethane. In addition, an N-vinyl compound may be also included. Examples of the N-vinyl compound include N-vinylformamide, N-vinylcarbazole, N-vinylacetamide, N-vinvlpyrrolidone, N-vinylcaprolactam, acryloyl morpholine, and derivatives thereof.

Preferred examples of the (b) urethane oligomer include epoxy {meth}acrylate, amine (moth)acrylate, aliphatic urethane (meth)acrylate, aromatic urethane (meth)acrylate, aliphatic polyester (meth)acrylate, and aromatic polyester (meth)actylate.

In order to raise the glass transition temperature (Tg) of the (b) urethane oligomer, an aromatic ring or an amide structure is introduced to the main chain of the oligomer so that the main chain structure becomes rigid or a large substituent maybe introduced to the side chain of the oligomer.

The (b) urethane oligomer may be a linear, branched chain-like, or dendritic oligomer, but a branched chain-like or dendritic oligomer is preferable in some cases. Since the viscosity of the branched chain-like or dendritic oligomer is relatively low, the hardness of a cured film can be enhanced despite that the viscosity of the active energy ray-curable composition for flooring materials is unlikely to be increased. The dendritic oligomer indicates an oligomer having a plurality of branched chains in one molecule.

Examples of the dendritic oligomer include a dendrimer, a hyperbranched oligomer, a star oligomer, and a graft oligomer. A dendrimer, a hyperbranched oligomer, a star oligomer, and a graft oligomer may be known compounds. Among these, a dendrimer or a hyperbranched oligomer is preferable and the hyperbranched oligomer is more preferable. It is difficult for a dendrimer or a hyperbranched oligomer to further increase the viscosity of the active energy ray-curable composition.

[(c) Hyperbranched Oligomer]

The (c) hyperbranched oligomer used in the present invention indicates a polyester-based hyperbranched oligomer formed by bonding a plurality of photopolymerisable functional groups to an oligomer to which two or more monomers are bonded to each other as a repeating unit. Since the polyester-based hyperbranched oligomer includes multiple photopolymerisable functional groups (for example, an acryloyl group and the like), the curing rate of the active energy ray-curable composition for flooring materials can be further increased and the hardness of the cured film can be further increased. The number of photopolymerisable functional groups included in one molecule of hyperbranched oligomer is preferably 6 or greater.

Examples of the (c) hyperbranched oliqomer which is the active energy ray-polymerizable compound used in the present invention include polyester hexa-functional acrylate, polyester nona-functional acrylate, and polyester 16-functional acrylate.

Examples of commercially available products of the oligomer are as follows.

CN131B, CN292, CN2272, CN2303, CN2304, CN509, CN551, CN790, CN2400, CN2401, CN2402, CN9011, and CN9026 (all manufactured by Sartomer Co., Ltd.); EBECRYL 600, EBECRYL 605, EBECRYL 3700, EBECRYL 3701, EBECRYL 3702, EBECRYL 3703, EBECRYL 1830, EBECRYL 80, EBECRYL 8210, and EBECRYL 8301 (all manufactured by Daieel Cytec Co., Ltd.); and Etercure 6147, Etercure 6172-1, Etercure 6153-1, Etercure 6175-3, Etercure 6234, and Etercure 6237 (all manufactured by Eternal Chemical Co., LTD.)

Particularly, examples of commercially available products of the (c) hyperbranched oligomer are as follows.

CN2300, CN2301, CN2302, CN2303, and CN2304 (all manufactured by Sartomsr Co., Ltd.); Etercure 6361-100 and Etercure 6362-100 (both manufactured by Eternal Chemical Co., LTD.); and V#1000 and V#1020 (both manufactured by OSAKA ORGANIC CHEMICAL INDUSTRY LTD.)

[(d) Polyfunctional Aerylate]

(d) A polyfunctional acrylate used in the present invention is other than both of the (b) urethane oligomer and the (c) hyperbranched oligomer, and examples thereof include acrylic acid or methacrylic acid and esters of polyhydric alcohol, for example, alkyl (meth)acrylate, cycloalkyl (meth)acrylate, halogenated alkyl (meth)acrylate, alkoxy alkyl (meth)acrylate, hydroxy alkyl (meth)acrylate, aminoalkyl (meth)acrylate, allyl (meth)acrylate, glycidyl (meth)acrylate, benzyl (meth)acrylate, phenoxy (meth) acrylate, mono or di(meth)acrylate of alkylene glycol or polyoxyalkylene glycol, trimethylolpropane tri(meth)acrylate, and pentaerythritol tetra(meth)acrylate; and (meth)acrylamide or a derivative thereof such as (meth)acrylamide, diacetone (meth)acrylamide, or N,N′-alkylene bis(meth)acrylamide which is mono-substituted or di-substituted with an alkyl group or a hydroxyaIkyl group, and an allyl compound such as allyl alcohol, allyl isocyanate, diallyl phthalate, or triallyl isocyanurate.

Monomers other than those described above may be used in combination for the composition of the present invention as long as the effects of the present invention are not impaired.

Examples of the (meth)acrylic monomer include polyethylene glycol (n is in a range of 3 to 14) di(meth)acrylate, trimethylolpropane EO-modified (n is in a range of 3 to about 14) tri(meth) acrylate, or phenol EO-modified (n is in a range of 3 to about 14) (meth)acrylate which has an ethylene glycol unit in a molecule; and 2-hydroxyethyl (meth)acrylate, 2-hydroxypropyl (meth)acrylate, or 4-hydroxybutyl (meth)acrylate, which has a hydroxyl group in a molecule. These (meth)acrylic monomers may be used alone or in combination of two or more kinds thereof.

In a case of applications in which curing shrinkage becomes an obstruction, it is possible to use isobornyl (meth)acrylate, norbornyl (meth)acrylate, dicyclopentenoxy ethyl (meth)acrylate, or dicyclopentenoxy propyl (meth)acrylate; acrylic acid ester or methacrylic acid ester of diethylene glycol dicyclopentenyl monoether, acrylic acid ester or methacrylic acid ester of polyoxvethylene or polypropylene glycol dicyclopentenyl monoether; dicyclopentenyl cinnamate, dicyclopentenoxy ethyl cinnamate, dicyclopentenoxy ethyl mono fumarate, or dicyclopentenoxy ethyl difumarate; a monomer, diacrylate, monomethacrylate, or dimethacrylate of 3,9-bis(1,1-bismethyl-2-oxyethyl)-spiro[5,5]undecane, 3,3-bis(1,1-bismethyl-2-oxyethyl)-2,4,8,10-tetraoxaspiro[5,5]undecane, 3,9-bis{2-oxyethyl}-spiro[5,5]undecane, or 3,3-bis(2-oxyethyl)-2,4,8,10-tetraoxaspiro[5,5]undecane; monoacrylate, diacrylate, monomethacrylate, or dimethacrylate of an ethylene oxide addition polymer or a propylene oxide addition polymer of spiroglycol of these; methyl ether of the mono(meth)acrylate, 1-azabicyclo[2,2,2]-3-octenyl (meth)acrylate, or bicyclo [2,2,1]-5-heptene-2,3-dicarboxyl monoallyl ester; and a (meth)acrylic monomer of dicyciopentadienyl (meth)acrylate, dicyciopentadienyl oxyethyl (meth)acrylate, or dihydrodicyclopentadienyl (meth)acrylate.

Examples of the active energy ray-polymerizable compound include monofunctional monomers, for example, (meth)acrylate including a substituent such as methyl, ethyl, propyl, butyl, amyl, 2-ethylhexyl, isooctyl, nonyl, dodecyl, hexadecyl, octadecyl, cyclohexyl, benzyl, methoxyethyl, butoxyethyl, phenoxyethyl, nonylphenoxyethyl, glycidyl, dimethylaminoethyl, diethylaminoethyl, isobornyl, dicyclopentanyl, dicyclopentenyl, or dicyclopentenyloxyethyl, 2-hydroxy-3-phenoxypropyl acrylate, vinylpyrrolidone, N-acryloyl morpholine, and N-vinylformamide.

Examples thereof further include polyfunctional monomers, for example, di(meth)acrylate such as 1,3-butylene glycol, 1,4-butanediol, 1,5-pentanediol, 3-methyl-1,5-pentanediol, 1,6-hexanediol, neopentyl glycol, 1,8-octanediol, 1,9-nonanediol, tricyclodecane dimethanol, ethylene glycol, polyethylene glycol, propylene glycol, dipropylene glycol, tripropylene glycol, or polypropylene glycol, di(meth)acrylate of tris(2-hydroxyethyl)isocyanurate, 2-(2-vinyloxyethoxy)ethyl (meth)acrylate, di(meth)acrylate of a diol obtained by adding 4 moles or more of ethylene oxide or propylene oxide to one mole of neopentyl glycol, di(meth)acrylate of a diol obtained by adding 2 moles of ethylene oxide or propylene oxide to 1 mole of bisphenol A, di- or tri(meth)acrylate of a triol obtained by adding 3 moles or more of ethylene oxide or propylene oxide to 1 mole of trimethylol propane, di(meth)acrylate of a diol obtained by adding 4 moles or more of ethylene oxide or propylene oxide to 1 mole of bisphenol A, trimethylolpropane tri(meth)acrylate, pentaerythritol tri(meth)acrylate, poly(meth)acrylate of dipentaerythritol, ethylene oxide-modified phosphoric acid (meth)acrylate, and ethylene oxide-modified alkyl phosphoric acid (meth)acrylate. These active energy ray-polymerizable compounds may be used alone or in combination of two or more kinds thereof.

### [Photopolymerization Initiator]

A known photopolymerization initiator of the related art may be used as the photopolymerization initiator used in the present invention, and specifically benzoin isobutyl ether, 2,4-diethyl thioxanthone, 2-isopropyl thioxanthone, benzyl, 2,4,6-trimethylbenzoyl diphenyl phosphine oxide 6-trimethyl benzoyl diphenyl phosphine oxide, 2-benzyl-2-dimethylamino-1-(4-morpholinophenyl)-butane-1-one, and bis(2,6-dimehtoxybensoyl)-2,4,4-trimethylpentyl phosphine oxide are preferably used. Further, examples of a molecule cleavage type photopolymerization initiator which can be used in combination include 1-hydroxy cyclohexyl phenyl ketone, benzoin ethyl ether, benzyl dimethyl ketal, methyl benzoyl formate, 2-hydroxy-2-methyl-1-phenylpropane-1-one, 1-(4-isopropylphenyl-2-hydroxy-2-methylpropane-1-one, and 2-methyl-1-(4-methylthiophenyl)-2-morpholinopropane-1-one. Further, examples of a hydrogen abstraction type photopolymerization initiator which can be used in combination include benzophenone, 4-phenyibenzophenone, isophthal phenone, and 4-benzoyl-4′-methyl-diphenyl sulfide. Among these, methyl benzoyl formate, in which yellowing caused by exposure to UV rays for a long period of time is less likely to occur, and which is capable of obtaining flexibility of a coating film at the time of curing and preventing a zip line, is more preferable.

Particularly, in a case where a light emitting diode (hereinafter, also referred to as an LED) is used as a light source, it is preferable to select a photopolymerization initiator in consideration of the emission peak wavelength of the LED. Examples of the photopolymerization initiator suitable for a case of using a UV-LED include 2-benzyl-2-dimethylamino-1-(4-morpholinophenyl)-butane-1-one,

2-(dimethylamino)-2-[(4-methylphenyl)methyl]-1-(4-morpholinophenyl)butane-1-one), bis(2,4,6-trimethylbenzoyl)phenyl phosphine oxide, 2,4,6-trimethylbenzoyl-diphenl-phosphine oxide, 2,4-diethyl thioxanthone, and 2-isopropylthioxanthone.

Amines, which do not cause an addition reaction with the above-described polymerizable components, such as trimethylamine, methyldimethanolamine, triethanoiamine, p-diethylaroinoacetophenone, ethyl p-dimethylaminobenzoate, isoamyl p-dimethyl aminobenzoate, N,N-dimethylbenzylamine, and 4,4′-bis(diethylamino)benzophenone can be used, as sensitizers, in combination with the above-described photopolymerization initiators.

These photopolymerization initiators may be used alone or in combination of two or more kinds thereof. The content of the photopolymerization initiator is not particularly limited, but approximately 2% to 20% by mass thereof is typically blended based on the total amount.

[(e) Antibacterial Agent]

Examples of the antibacterial agent used in the present invention include inorganic antibacterial agents and organic antibacterial agents. As the inorganic antibacterial agent, an agent in which metals such as silver, copper, and zinc, a compound thereof, and a mixture of these are allowed to be supported by an inorganic material is used. Examples of the carrier include (1) ion-exchange type antibacterial agents such as zirconium, phosphate, magnesium aluminosiiicate, aluminosilicate, aluminum phosphate, and calcium silicate; (2) soluble type antibacterial agents such as soluble glass; (3) chemical coupling type antibacterial agents such as calcium zinc phosphate; (4) metallic silver-supported type antibacterial agents such as calcium phosphate, titanium oxide, and spherical silica; and (5) other antibacterial agents such as silica gel and ultratine particle zinc oxide.

As the antibacterial agent used in the present invention, an antibacterial agent which is extremely safe with respect to a human body, does not adversely affect the active energy ray-curable composition for flooring materials, and is in a liquid state or a solid state at room temperature can be used. Examples of such an antibacterial agent include antibacterial ceramic.

As the antibacterial ceramic, one which is in a solid state at room temperature and in which at least a part or the entirety of metal atoms of, for example, conventional ceramic is substituted with metal ions with more excellent antibacterial properties is exemplified.

Specific examples of antibacterial metal ions include ions of silver, copper, sine, mercury, tin, lead, bismuth, cadmium, chromium and thallium. Among these, ions of silver, copper, or zinc are preferable.

In a case where silver ions are used as antibacterial, metal ions, the content of the silver ions in the antibacterial ceramic is in a range of 0.1% to 15% by weight and preferably in a range of 0.1% to 5% by weight. In a case where, copper ions or zinc ions are used as antibacterial metal ions, the content of the copper ions or zinc ions in the antibacterial ceramic is preferably in a range of 0.1% to 8% by weight.

A silver-based antibacterial agent is used as the (e) antibacterial agent in consideration of antibacterial, effects and influence of toxicity. Using the antibacterial action of silver, it is possible to inhibit or prevent the growth of microorganisms. Further, antibacterial agents in which a silver-supported amount of silver ions, silver complex ions, or silver colloid is around 3% are commercially available.

In a case where the antibacterial agent is present in a state of particles dispersed in the active energy ray-curable composition, antibacterial ceramic is preferable in terms that defoaming is easily performed and defects of a cured coating film can be prevented because bubbles in the composition, are collected in the vicinity of the antibacterial agent.

Examples of such commercially available products include Bactelite and Bactekiller (both manufactured by Fuji Chemical Industries, Ltd.).

The amount of the antibacterial agent to be mixed into the composition is preferably in a range of 0.01% to 3% by mass and more preferably in a range of 0.1% to 2% by mass in a case where an agent having a supported amount of 3% is used. Typically, the transaction of the antibacterial agent has been made in the powder form, but the antibacterial agent in the powder form needs to be dispersed using a stirrer, in order to be dispersed in the active energy ray-curable composition. However, in a case where the dispersibility of the antibacterial agent is insufficient, since the antibacterial agent is aggregated and the antibacterial effect appears only at a specific site with the collected antibacterial agent, the above-described commercially available products in which antibacterial agents are dispersed in monomers in advance are remarkably effective in terms that uniform antibacterial properties are exhibited. In addition, a cured film is smooth because the antibacterial agent is uniformly dispersed, and flooring materials and floors which are installed using the active energy ray-curable composition for antibacterial flooring materials, of the present invention have persistent antibacterial effects with respect to daily clearing work using mops or floorcloths.

When organic particles or inorganic particles are added to the active energy ray-curable composition for flooring materials of the present invention, the scratch resistance thereof becomes more excellent. Examples of the organic particles used in the present invention include an acrylic resin, a urethane resin, a fluorine resin, silicone, a melamine resin, and a styrene resin and examples of the inorganic particles include calcium carbonate, silica, alumina, titanium oxide, magnesium hydroxide, zinc oxide, calcium silicate, and aluminum hydroxide. These may be used alone or in combination and, among these, alumina is preferably used. Further, the average particle diameter of the above-described organic particles and inorganic particles is preferably 10 μm or less. The organic particles and inorganic particles may be added alone or may be added after being dispersed in a suitable dispersion medium in advance.

The amount of the organic particles and inorganic particles to be added is preferably 10 parts by weight or less, and more preferably in a range of 1 to 5 parts by weight, with respect to 100 parts by weight of the active energy ray-polymerizable c ompound.

[Colorant]

It is possible to provide design properties for the active energy ray-curable compositian for flooring materials by coloring the composition. For coloration, an inorganic pigment or an organic pigment can be used as a conventionally known colorant. An organic pigment or an inorganic pigment can be used as a pigment used in the present invention.

Examples of the inorganic pigment which can be used include silicas such as sulfate of alkaline earth metal, carbonate, fine silicic acid, and synthetic silicate; an inorganic pigment used as a white pigment such as calcium silicate, alumina, an alumina hydrate, titanium oxide, zinc oxide, talc, or clay; iron oxide; and carbon black produced by a known method such as a contact method, a furnace method, or a thermal method.

Moreover, examples of the organic pigment which can be used include azo pigments (including azo lake, an insoluble azo pigment, a condensed azo pigment, and a chelate aso pigment), polycyclic pigments (such as a phthalocyanine pigment, a perylene pigment, a perinone pigment, an anthraquinone pigment, a quinacridone pigment, a dioxazine pigment, a thioindigo pigment, an isoindolinone pigment, and a quinophthaione pigment), dye chelate (such as basic dye chelate or acid dye chelate), nitre pigments, nitroso pigments, and aniline black.

Specific examples of the pigment which is carbon black include No. 2300, No. 900, No. 960, MCF 88, No. 33, Ho. 40, No. 45, No. 52, MA 7, MA8, MA100, and No. 2200B (manufactured by Mitsubishi Chemical Corporation); Raven 5750, Raven 5250, Raven 5000, Raven 3500, Raven 1255, and Raven 700 (manufactured by Columbia Carbon, Inc.); Regal 400R, Regal 330R, Regal 660R, Mogul L, Mogul 700, Monarch 800, Monarch 880, Monarch 900, Monarch 1000, Monarch 1100, Monarch 1300, and Monarch 1400 (manufactured by Cabot Corporation); and Color Black FW1, Color Black FW2, Color Black FW2V, Color Black FW18, Color Black FW200, Color Black S150, Color Black S160, Color Black S170, Printex 35, Printex U, Printex V, Printex 140U, Special Black 6, Special Black 5, Special Black 4A, and Special Black 4 (manufactured by Degussa AG).

Examples of pigments used for a yellow color include C. I. Pigment Yellow 1, 2, 3, 12, 13, 14, 16, 17, 73, 74, 75, 83, 93, 95, 97, 98, 109, 110, 114, 120, 128, 129, 138, 150, 151, 154, 155, 130, 185, and 213.

Further, examples of pigments used for a magenta, color include C. I. Pigment Red 5, 7, 12, 48 (Ca), 48 (Mn), 57 (Ca), 57:1, 112, 122, 123, 168, 184, 202, and 209, and C. I. Pigment Violet 19.

Further, examples of pigments used for a cyan color include C. I. Pigment Blue 1, 2, 3, 15:3, 15:4, 60, 16, and 22.

Moreover, as pigments used for a white color, C. I. Pigment White 6, 18, and 21 can be used according to the purpose thereof, and titanium oxide with an excellent opacity is preferable. Specific examples thereof include “TITANIX JR-301, 403, 405, 600A, 605, 600E, 603, 305, 806, 701, 800, and 803”, and “TITANIX JA-1, C, 3, 4, and 5” (all manufactured by TAYCA CORPORATION); “TXPAQUE CR-50, 50-2, 57, 80, 90, 93, 95, 953, 97, 60, 60-2, 63, 67, 58, 58-2, and 85”, “TIPAQUE R-820, 830, 930, 550, 630, 680, 670, 580, 780, 780-2, 850, and 855”, “TIPAQUE A-100 and 220”, “TIPAQUE W10”, “TIPAQUE PF-740 and 744”, “TTO-55(A), 55(B), 55 (C), 55(D), 55(S), 55(N), 51(A), and 51(C)”, “TTO-S-1 and 2”, and “TTO-M-1 and 2”, (all manufactured by ISHIHARA SANGYO KAISHA, LTD.); and “TI-PURE R-900, 902, 960, 706, and 931” (manufactured by Du Pont).

[Additive]

As other additives, conventionally known additives such as a photosensitizer, an antifoaming agent, a leveling agent, a UV absorbent, a light stabilizer, a lubricant, and a matting agent can be added to the active energy ray-curable composition for flooring materials. In addition, an antibacterial agent or an antistatic agent can be suitably added if necessary for the purpose of providing functionality.

[(f) Acrylic Leveling Agent]

As the leveling agent used for the active energy ray-curable composition for flooring materials of the present invention, (f) an acrylic leveling agent is preferable. The surface tension reduction ability of the (f) acrylic leveling agent is approximately from 0.10 to 0.3 mN/m, which is smaller than several mN/m of a silicon-based leveling agent by one digit. Further, since the degree of activity of the acrylic leveling agent is low and the surface tension thereof is unlikely to be decreased, the acrylic leveling agent is particularly suitable for the active energy ray-curable composition for flooring materials of the present invention, in which re-coating is assumed, and has an excellent usability because coating unevenness caused by wetting failure can be suppressed.

It is preferable that the (f) acrylic leveling agent is an acrylic polymer in which either of n-butyl alcohol and iso-butyl alcohol contains in an amount of 80% or greater of the total amount of the leveling agent. As the composition thereof, n-butyl acrylate/iso-butyl acrylate/vinyl toluene=46/51/3 (ratio of weight %), the number average molecular weight Mn=3500, the weight average molecular weight Mw=15,000, and Mw/Mn=4.3 can be exemplified. Further, preferred examples of commercially available products thereof include BYK-350 and BYK-361N (manufactured by BYK-Chemie GmbH) and Resiflow LG-99 (manufactured by Estron Chemical Inc.).

In order to improve storage stability, polymerization inhibitors such as hydroquinone, methoquinone, a hindered amine-based light stabilizer, a hindered phenol-based light stabilizer, di-t-butyl hydroquinone, P-methoxyphenol, butyl hydroxy toluene, and nitrosamine salts can be added to the active energy ray-curable composition for flooring materials of the present invention in an amount of 0.01% to 2% by mass.

In addition, a dispersant may be used to improve dispersion stability of a filler or a colorant. Examples of the dispersant include AJISPER PB821, PB822, PB381, and PB817 (manufactured by Ajinomoto Fine-Techno Co., Inc.); SOLSPERSE 24000GR, 32000, 33000, 36000, 33000, 41000, and 71000 (manufactured by Lubrizoi Corporation); EFKA-7701 (manufactured by BASF Corporation); and DISPARLOM DA-703-50, DA-705, and DA-725 (manufactured by Kusumoto Chemicals, Ltd.), but the examples are not limited to these. The amount of the dispersant to be used is preferably in a range of 10% to 80% by weight and particularly preferably in a range of 20% to 60% by weight with respect to the filler. In a case where the amount of the dispersant to be used is less than 10% by weight, the dispersion stability tends to be insufficient. In a case where the amount thereof exceeds 80% by mass, the viscosity of the active energy ray-curable composition for flooring materials tends to be higher and leveling properties of the active energy ray-curable composition for flooring materials are degraded.

For the purpose of providing adhesive properties for a printed base material, it is possible to blend non-reactive resins such as an acrylic resin, an epoxy resin, a terpene phenol resin, and rosin ester with the base material.

(Method for Producing Active Energy Ray-Curable Composition for Flooring Materials)

An active energy ray-curable composition can be obtained by blending necessary active energy ray-polymerizable compounds and heating the mixture while stirring and mixing a photopolymerization initiator, a photopolymerization inhibitor, and an antibacterial agent. In order to obtain the active energy ray-curable composition for flooring materials of the present invention, an additive such as a surface tension adjusting agent or a lubricant necessary for the active energy ray-curable composition, for flooring materials is added and then stirred, thereby obtaining the active energy ray-curable composition.

(Viscosity of Active Energy Ray-Curable Composition for Flooring Material)

Since a streaky feeling may occur at the time of finishing after curing when the viscosity of the active energy ray-curable composition for flooring materials of the present invention is excessively high, the viscosity thereof is preferably in a range of 50 to 1,000 mPa·sec (25° C.) and most preferably in a range of 100 to 400 mPa·sec (25° C.).

(Coating Method)

As a coating method of the active energy ray-curable composition for flooring materials, application of the composition is performed using a roller or brush. Further, the active energy ray-curable composition for flooring materials can be used for various inks or for coating. As the coating method, known techniques such as a roll coater, a gravure coater, a flexo coater, an air doctor coater, a blade coater, an air knife coater, a squeeze coater, an impregnation coater, a transfer roll coater, a kiss coater, a curtain coater, a cast coater, a ay coater, a die coater, an offset printing machine, and a screen printing machine can be suitably employed.

(Curing)

The active energy ray-curable composition for flooring materials is subjected to a curing reaction by performing irradiation with active energy rays and preferably DV rays. The light sources of the UV rays can be used for curing without any problems as long as the light sources typically used for a UV-curable coating agent such as a metal halide lamp, a xenon lamp, a carbon arc lamp, a chemical lamp, a low-pressure mercury lamp, and a high-pressure mercury lamp are used. For example, the curing can be performed using commercially available light sources such as a H lamp, a D lamp, and a V lamp (manufactured by Fusion Systems).

In recent years, there has been a demand for the active energy ray-curable composition for flooring materials is to be cured or semi-cured using sources of irradiation with active energy rays such as a UV-LED or UV light emitting semiconductor laser. For example, in a case where the sources are used for the active energy ray-curable composition for flooring materials, flooring materials can be formed by performing a process of coating a floor with the active energy ray-curable composition for flooring materials and then curing the active energy ray-curable composition by irradiating the composition with active energy rays whose wavelength peak is present in a range of 365 to 420 nm using a light emit ting diode (LED).

(Movable Active Energy Ray Irradiation Device)

The movable active energy ray irradiation device used in the present invention is a device in which a light source of irradiation with the active energy rays and preferably UV rays is fixed to a frame connected to a main body supported by two or more skeletons and a wheel in contact with at least the flooring materials. The structure thereof is formed such that the wheel in contact with the flooring materials passes through the inner side than the range which is irradiated with active energy rays, and defects such as wheel marks are not generated because the wheel passes over the active energy ray-curable composition which is cured by active energy rays.

It is preferable that the movable active energy ray irradiation device has a mechanism for satisfying the curing conditions at the time of irradiation with active energy rays. Accordingly, it is more preferable that the movable active energy ray irradiation device has a mechanism in which the movement rate can be automatically controlled or a mechanism to inform the movement rate in a case where the movement rate is excessively high.

### EXAMPLES

Hereinafter, the present invention will be described in more detail with reference to examples, but the present, invention is not particularly limited to the following examples. Further, the “part” in the following examples indicates part by weight.

### Example 1

### Preparation of (1) Active Energy Ray-Curable Composition for Flooring Material

After 10.0 parts of co-carboxy-polycaprolactone monoacrylate “Aronix M-5300” (manufactured by Toagosei Company, Ltd.), 22.0 parts of urethane oligomer “CN9026” (manufactured by SARTOMER Company Inc.), 20.5 parts of hyperbranched polyester acrylate “CN2303” (manufactured by SARTOMER Company Inc.), 23.9 parts of 1,6-hexanediol diacrylate “MIRAMER M202” (manufactured by Mi won Specialty Chemical Co., Ltd.), 14.0 parts of 3 mol of ethylene oxide added-trimethylolpropane (EO)3 triacrylate “MIRAMER M3130” (manufactured by Mi won Specialty Chemical Co., Ltd.), 2.0 parts of 1-hydroxy-cyclohexyl-phenyl-ketone “Irgacure184” (manufactured by BASF Corporation), 5.0 parts of methylbenzoyl formate “DAROCUR MBF” (manufactured by BASF Corporation), and 0.1 parts of butyl hydroxy toluene “H-BHT” (manufactured by Honshu Chemical Industry Co., Ltd.) were added, heated at 60° C. for 30 minutes, and then stirred, 1.0 part of a polyethylene dispersion “CC7610” (manufactured by Lubrizol Corporation) as a lubricant and 1.5 parts of a leveling agent “BYK-350” (manufactured by BYK-Chemie GmbH) were added thereto, and then the mixture was sufficiently mixed. Next, the mixture was filtered using a filter having an opening diameter of 100 μm, thereby obtaining (1) an active energy ray-curable composition for flooring materials.

Further, the surface (walking surface) of composition vinyl floor tile “MATICO V” (manufactured by TOLI Corporation) was coated with the active energy ray-curable liquid resin composition (1) having the above-described mixture such that the thickness thereof became 40 μm, and the surface thereof was irradiated with UV rays (irradiation dose: 500 mJ/cm²) as active energy rays using a movable active energy ray irradiation device TIGER (manufactured by HID Ultraviolet, LLC) to cure the active energy ray-curable composition for flooring materials, thereby obtaining a flooring material.

In addition, in Examples 2 to 9 shown in Tables 1 and 2 and Comparative Examples 1 to 4 shown in Table 3, flooring materials were obtained in the same manner as in Example 1.

Further, in Examples 2 and 3, a silver-based antibacterial agent, Bactelite MP-102SVC715 (manufactured by Fuji Chemical Industries, Ltd.), in which acrylic monomers were used as a dispersion medium was added to the formulation of Example 1 as an antibacterial agent in the amount of parts by weight shown in the tables below, and the mixture was sufficiently mixed with each other and, similarly, filtered using a filter having an opening diameter of 100 μm. With respect to the filtered composition, the antibacterial effects were confirmed.

TABLE 1

| | | Examples | | | | | | |
|---|---|---|---|---|---|---|---|---|
| | | 1 | 2 | 3 | 4 | 5 | 6 | 7 |
| (a) Carboxyl | M-5300 | 10.0 | 10.0 | 10.0 | | 10.0 | 10.0 | 10.0 |
| group-containing active | Photomer4703 | | | | 10.0 | | | |
| energy ray-polymerizable | | | | | | | | |
| compound | | | | | | | | |
| (b) Urethane oligomer | CN9026 | 22.0 | 22.0 | 22.0 | 22.0 | 22.0 | 22.0 | 22.0 |
| (c) Hyperbranched oligomer | CN2303 | 20.5 | 20.5 | 20.5 | 20.5 | 20.5 | 20.5 | 20.5 |
| (d) Polyfunctional acrylate | M-202 | 23.9 | 2.9 | 23.9 | 23.9 | 23.9 | 23.9 | 23.9 |
| | M3130 | 14.0 | 14.0 | 14.0 | 14.0 | 14.0 | 14.0 | 14.0 |
| Monofunctional acrylate | Light acrylate PO-A | | | | | | | |
| Photopolymerization | Irogacure184 | 2.0 | 2.0 | 2.0 | 2.0 | 2.0 | 2.0 | 2.0 |
| initiator | DAROCUR MBF | 5.0 | 5.0 | 5.0 | 5.0 | 5.0 | | |
| | KIP-100F | | | | | | 5.0 | |
| | DAROCUR1173 | | | | | | | 5.0 |
| Polymerization inhibitor | H-BHT | 0.1 | 0.1 | 0.1 | 0.1 | 0.1 | 0.1 | 0.1 |
| (e) Antibacterial agent | Bactelite MP-1025VC715 | | 1.0 | 2.0 | | | | |
| (f) Acrylic leveling agent | BYK -350 | 1.5 | 1.5 | 1.5 | 1.5 | | 1.5 | 1.5 |
| | Resiflow LG -99 | | | | | 1.5 | | |
| Silicone-based leveling | KF351A | | | | | | | |
| agent | BYK-UV3500 | | | | | | | |
| Lubricant | CC7610 | 1.0 | 1.0 | 1.0 | 1.0 | 1.0 | 1.0 | 1.0 |

| | | | | | | | |
|---|---|---|---|---|---|---|---|
| Total | 100.0 | 101.0 | 102.0 | 100.0 | 100.0 | 100.0 | 100.0 |

TABLE 2

Examples

| | | 8 | 9 |
|---|---|---|---|
| (a) Carboxyl group- | M-5300 | 10.0 | 10.0 |
| containing active | Photomer4703 | | |
| energy ray-poly- | | | |
| merizable compound | | | |
| (b) Urethane oligomer | CN9026 | 22.0 | 22.0 |
| (c) Hyperbranched | CN2303 | 20.5 | 20.5 |
| oligomer | | | |
| (d) Polyfunctional | M-202 | 23.9 | 23.9 |
| acrylate | M3130 | 14.0 | 14.0 |
| Monofunctional | Light acrylate | | |
| acrylate | PO-A | | |
| Photopolymerization | Irugacure184 | 2.0 | 2.0 |
| initiator | DAROCUR MBF | 5.0 | 5.0 |
| | KIP-100F | | |
| | DAROCUR1173 | | |
| Polymerization | H-BHT | 0.1 | 0.1 |
| inhibitor | | | |
| (e) Antibacterial | Bactelite | | |
| agent | MP-102SVC715 | | |
| (f) Acrylic leveling | BYK-350 | | |
| agent | Resiflow LG-99 | | |
| Silicone-based leveling | KF351A | 1.5 | |
| agent | BYK-UV3500 | | 1.5 |
| Lubricant | CC7610 | 1.0 | 1.0 |

| | | |
|---|---|---|
| Total | 100.0 | 100.0 |

TABLE 3

| | | Comparative Examples | | | |
|---|---|---|---|---|---|
| | | 1 | 2 | 3 | 4 |
| (a) Carboxyl group- | M-5300 | | 10.0 | 10.0 | 10.0 |
| containing active | Photomer4703 | | | | |
| energy ray-poly- | | | | | |
| merizable compound | | | | | |
| (b) Urethane oligomer | CN9026 | 22.0 | | 22.0 | 22.0 |
| (c) Hyperbranched | CN2303 | 20.5 | 20.5 | | 58.4 |
| oligomer | | | | | |
| (d) Polyfunctional | M-202 | 23.9 | 23.9 | 23.9 | |
| acrylate | M3130 | 14.0 | 36.0 | 34.5 | |
| Monofunctional | Light acrylate | 10.0 | | | |
| acrylate | PO-A | | | | |
| Photopolymerization | Irugacure184 | 2.0 | 2.0 | 2.0 | 2.0 |
| initiator | DAROCUR MBF | 5.0 | 5.0 | 5.0 | 5.0 |
| | KIP-100F | | | | |
| | DAROCUR1173 | | | | |
| Polymerization | H-BHT | 0.1 | 0.1 | 0.1 | 0.1 |
| inhibitor | | | | | |
| (e) Antibacterial | Bactelite | | | | |
| agent | MP-102SVC715 | | | | |
| (f) Acrylic leveling | BYK-350 | 1.5 | 1.5 | 1.5 | 1.5 |
| agent | Resiflow LG-99 | | | | |
| Silicone-based leveling | KF351A | | | | |
| agent | BYK-UV3500 | | | | |
| Lubricant | CC7610 | 1.0 | 1.0 | 1.0 | 1.0 |

| | | | | |
|---|---|---|---|---|
| Total | 100.0 | 100.0 | 100.0 | 100.0 |

Aronix M-5300: ω-carboxy-polycaprolactone monoacrylate (manufactured by Toagosei Company, Ltd.)

Photomer4703: Carboxyl group-modified acrylate and 2-hydroxy-3-phenoxypropyl acrylate (manufactured by IGM, Inc.)

CN9026: hexafunctional aliphatic urethane oligomer (manufactured by SARTOMER Company Inc.)

CN2303: hyperbranched polyester hexafunctional acrylate (manufactured by SARTOMER Company Inc.)

MIRAMER M202: 1,6-Hexanediol (EO)n diacrylate (manufactured by Miwon Specialty Chemical Co., Ltd.)

MIRAMER M-3130: 3 mol of ethylene oxide-added trimethylolpropane (EO)3 triacrylate (manufactured by Miwon Specialty Chemical Co., Ltd.)

Light acrylate PO-A: 2-phenoxyethyl acrylate (manufactured by KYOEISHA CHEMICAL Co., LTD.)

Irgacure184: 1-hydroxy-cyclohexyl-phenyl-ketone (manufactured by BASF Corporation)

DAROCUR MBF: methylbenzoyl formate (manufactured by BASF Corporation)

KIP-100F:

oligo(2-hydroxy-2-methyl-1-(4-(methylvinyl)phenyl)propanone) (manufactured by Lamberti)

DAROCUR1173: 2-hydroxy-2-methylpropiophenone (manufactured by BASF Corporation)

H-BHT: butyl hydroxy toluene (polymerization inhibitor) (manufactured by Honshu Chemical Industry Co., Ltd.)

Bactelite MP-102SVC715: silver-based antibacterial agent using acrylic monomers as a dispersion medium (manufactured by Fuji Chemical Industries, Ltd.)

BYK-350: acrylic leveling agent (manufactured by BYR-Chemie GmbH) p Resiflow LG-99: acrylic leveling agent (manufactured by ESTROM CHEMICAL Inc.)

KF351A: polyether-modified dimethyl silicone-based leveling agent (manufactured by Shin-Etsu Chemical Co., Ltd.)

BYK-DV3500: silicone-based leveling agent (manufactured by BYK-Chemie GmbH)

CC7610: lubricant of polyethylene/fatty acid ester dispersion (manufactured by Lubrizol Corporation)

(Evaluation Method)

The methods of evaluating the active energy ray-curable compositions for flooring materials in Examples 1 to 9 and Comparative Examples 1 to 4 are shown. In addition, the antibacterial properties were confirmed with respect to Examples 2 and 3.

[Contamination Resistance (Heel Mark Resistance)]

Five standard rubber blocks were put into a Snell capsule tester described in JIS K 3920, the coating surface of flooring materials was set such that the surface thereof was brought into contact with the rubber blocks, normal rotation for 5 minutes and reverse rotation for 5 minutes at a rotation speed of 40 rpm were repeated by two cycles, the floor sheet was taken out, the coating surface was wiped with dry cloth, and the degree of attachment of heel, marks was observed.

A.: No attachment

B: Attached heel marks were slightly found

C: Attached heel, marks were significant

[Zip Line]

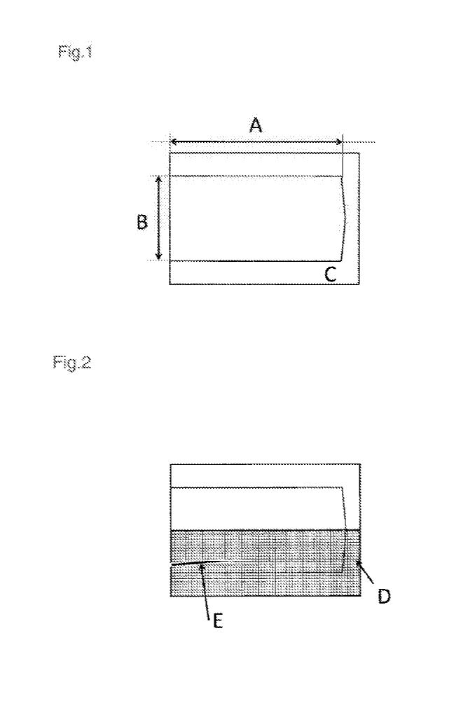

After a grind gauge having dimensions of a path size width of 3 inches, a length of 7 inches, and a depth of 6 mils was uniformly coated with each of the active energy ray-curable composition for flooring materials, half of the coating surface was put into a light shielding container so as to be light-shielded, and the half of the coating surface was irradiated with active energy rays at an irradiation dose of 500 mJ/cm² using a movable active energy ray irradiation device TIGER (manufactured by HID Ultraviolet, LLC), thereby obtaining a coating film surface having an uncured portion and a cured portion. Absence or presence of a defect generated in the coating film and the depth of the generated defect were examined (see FIGS. 1 and 2).

[Re-coatability]

PET films Lumirror S10 having a thickness of 100 μm (manufactured by Toray Industries, Inc.) were coated with the active energy ray-curable compositions of the examples and the comparative examples, respectively, such that the film thickness thereof became approximately 20 μm using an applicator, and cured at an irradiation dose of 500 mJ/cm² using a high-pressure mercury lamp (manufactured by EYE GRAPHICS Co., Ltd.), thereby obtaining samples. The obtained samples were allowed to stand in a dark room at room temperature for 1 week after preparation, the coating films were re-coated with the active energy ray-curable compositions using the applicator again, respectively, such that the film thickness thereof became approximately 20 μm and then cured under the same conditions as described above. With respect to the samples having laminated coatings, the quality of adhesive properties was determined by performing evaluation in conformity with the cross-cut tape method described in JIS K 5400. The evaluation criteria are shown in Table 4.

TABLE 4

| Evaluation scores | State of scratches |
|---|---|
| 10 | Each cut is thin and both ends thereof are smooth. |
| | There is no peeling with respect to every point of |
| | the intersections of cuts and every square. |
| 8 | Peeling is slightly found with respect to the |
| | intersection of cuts, but there is not peeling with |
| | respect to every square. The area of the defective |
| | portions is within 5% based on the area of the entire |
| | square. |
| 6 | Peeling is significant with respect to both sides |
| | of a cut and the intersection of cuts. The area |
| | of the defective portions is in a range of 5% to |
| | 15% based on the area of the entire square. |
| 4 | The width of the peeling due to a cut is large. The |
| | area of the defective portions is in a range of 15% |
| | to 35% based on the area of the entire square. |
| 2 | The width of the peeling due to a cut is large. The |
| | area of the defective portions is in a range of 15% |
| | to 35% based on the area of the entire square. |
| 0 | The area of the peeling is 65% or greater based on |
| | the area of the entire square. |

[Hue Change ΔE]

A weathering test was performed using a Sunshine Weather Meter S80 (manufactured by Suga Test Instruments Co., Ltd.). The test was performed under the rainfall conditions of one hour cycle (watering for 12 minutes and irradiation with light for 48 minutes) for 300 hours. The hue change after the weathering test was evaluated based on the following ΔE values.

The hue change was evaluated using a color difference meter CR-310 (manufactured by KONICA MINOLTA, INC.)

ΔE=((L*_{b}−L*ₐ)²+(a*_{b}−a*ₐ)²+(b*_{b}−b*ₐ)²)^{1/2}

(In the formula, ΔE represents a hue change, L*ₐ, a*ₐ, and b*ₐ each represent values of L*, a*, and b* before an outdoor exposure acceleration, test is performed, and L*_{b}, a*_{b}, and b*_{b} each represent values of L*, a*, and b* after the outdoor exposure acceleration test is performed.)

The evaluation criteria are as follows.

A: The hue change is less than 1.0

B: The hue change is in a range of 1.0 to less than 3.0

C: The hue change is 3.0 or greater

[Scratch Resistance]

Steel Wool No. 000 was mounted on the tip of an arm of a plane friction test machine (manufactured by TOYO SEIKI SEISAKU-SHO, LTD.), 500 g of a load was applied thereto, the surface of a coating film was reciprocally rubbed 100 times, and then scratches were observed.

A: Scratches were not found

B: Scratches were not noticeable

C: Scratches were slightly noticeable

D: Many scratches were found

[Antibacterial Properties]

A test was performed using Art paper coated with the compositions of the examples and the comparative examples, as samples, in conformity with the description (mainly, in “5 Test method”) of “Antibacterial products—Test for antibacterial activity and efficacy” which is a method for testing JIS Z 2801-2010 plastic products or the like. Escherichia coli (NBRC3972) and Staphylococcus aureus (NBRC12732) were used as the strains in a test bacterial suspension, the bacterial suspension (bacterial suspension NB concentration 1/100 NB) was added dropwise to the surface, of samples coated with active energy ray-curable compositions for antibacterial flooring materials, the surface was covered with a film so that the bacterial suspension was brought into close contact therewith, and the bacteria were cultured at a temperature of 35±1° C., at a relative humidity of 90% or greater for 24 hours. Subsequently, the bacterial suspension was washed out and the number of viable bacterial per 1 cm² of a sample was measured.

In a case where the obtained antibacterial activity value was 2.0 or greater, the definition is made that the antibacterial agent has antibacterial effects, and the definition is used for determination criteria.

The antibacterial activity value is calculated using the following formula.

Antibacterial activity value (R)=Ut−At

Ut: Logarithmic value of number of viable bacterial after sample to which antibacterial agent is not added is cultured

At: Logarithmic: value of number of viable bacterial after sample to which antibacterial agent is added is cultured

A: The antibacterial activity value (R) is 2.0 or greater

B: The antibacterial activity value (R) is less than 2.0

The results of evaluation performed on antibacterial properties confirmed in Examples 2 and 3 are shown in Table 5.

TABLE 5

| | | Example 1 | Example 2 | Example 3 |
|---|---|---|---|---|
| Antibacterial properties | Ut | 5.62 | — | — |
| (Escherichia coli) | At | 5.62 | −0.20 | −0.20 |
| Logarithmic value of | | | or less | or less |
| inoculated bacteria: 4.33 | Anti- | 0 | 5.8 | 5.8 |
| Base material: Art paper | bacterial | | or greater | or greater |
| | activity | | | |
| | value (R) | | | |
| | Determi- | B | A | A |
| | nation | | | |
| Antibacterial properties | Ut | 2.75 | — | — |
| (Staphylococcus aureus) | At | 2.75 | −0.20 | −0.20 |
| Logarithmic value of | | | or less | or less |
| inoculated bacteria: 4.10 | Anti- | 0 | 2.9 | 2.9 |
| Base material: Art paper | bacterial | | or greater | or greater |
| | activity | | | |
| | value (R) | | | |
| | Determi- | B | A | A |
| | nation | | | |

The evaluation results are collectively shown in Tables 6 and 7.

TABLE 6

| | Example | | | | | | | | |
|---|---|---|---|---|---|---|---|---|---|
| | 1 | 2 | 3 | 4 | 5 | 6 | 7 | 8 | 9 |
| Contamination | A | A | A | A | A | A | A | A | A |
| resistance | | | | | | | | | |
| Zip line | A | A | A | A | A | B | B | A | A |
| Re-coatability | 10 | 10 | 10 | 10 | 10 | 10 | 10 | 8 | 6 |
| Hue change (ΔE) | A | A | A | A | A | B | B | A | A |
| Scratch | A | A | A | A | A | A | A | A | A |
| resistance | | | | | | | | | |
| Antibacterial | B | A | A | — | — | — | — | — | — |
| properties | | | | | | | | | |

TABLE 7

Comparative Examples

| | 1 | 2 | 3 | 4 |
|---|---|---|---|---|
| Contamination resistance | C | A | A | A |
| Zip line | A | C | A | A |
| Re-coatability | 10 | 4 | 10 | 8 |
| Hue change (ΔE) | B | B | A | A |
| Scratch resistance | C | D | D | D |
| Antibacterial properties | — | — | — | — |

As a result, it was confirmed that the active energy ray-curable compositions for flooring materials obtained in Examples were active energy ray-curable compositions for flooring materials, which, was unlikely to cause a curing defect between a cured portion and an uncured portion even when a movable irradiation device having a light source of active energy rays was used, was unlikely to cause yellowing attributable to exposure to natural light for a long period of time and exhibits re-coatability was high, while exhibiting an excellent contamination resistance, and it was possible to obtain those compositions and the construction method therefor.

Further, the effects of the antibacterial agent were also confirmed.

### REFERENCE SIGNS LIST

A: length of 7 inches

B: width of 3 inches

C: depth of 7 mils

D: oblique portion

E: zip line

1. An active energy ray-curable composition for flooring materials, which comprises an active energy ray-polymerizable compound and a photopolymerization initiator,
wherein the active energy ray-polymerizable compound includes the following materials (a), (b), (c), and (d):
(a) a carboxyl group-containing active energy ray-polymerizable compound represented by Formula (1); 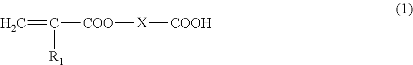
wherein R1 represents a hydrogen atom or a methyl group, and X represents an organic group:
(b) a urethane oligomer;
(c) a hyperbranched oligomer; and
(d) polyfunctional acrylate.

2. The active energy ray-curable composition for flooring materials according to claim 1, wherein the photopolymerization initiator is methyl benzoyl formate.

3. The active energy ray-curable composition for flooring materials according to claim 1, which further comprises (e) an antibacterial agent.

4. The active energy ray-curable composition for flooring materials according to claim 1, wherein the (e) antibacterial agent is a silver-based antibacterial agent.

5. The active energy ray-curable composition for flooring materials according to claim 1, which further comprises (f) an acrylic leveling agent.

6. An construction method, which comprises:
curing the active energy ray-curable composition for flooring materials according to claim 1 using a movable active energy ray irradiation device.

7. Flooring materials which are obtained by the construction method according to claim 6.

8. A floor for which the flooring materials according to claim 7 are used.
